(19) United States
(12) Patent Application Publication
(10) Pub. No.: US 2012/0269068 A1
(43) Pub. Date: Oct. 25, 2012

(54) TESTING SYSTEM

(75) Inventors: MING-HUNG CHOU, TAIPEI CITY (TW); CHING-FENG HSIEH, TAIPEI CITY (TW)

(73) Assignee: ASKEY COMPUTER CORP., NEW TAIPEI CITY (TW)

(21) Appl. No.: 13/157,634

(22) Filed: Jun. 10, 2011

(30) Foreign Application Priority Data
Apr. 19, 2011 (TW) 100113515

(51) Int. Cl. H04L 12/26; H04B 10/08

(52) U.S. Cl. 370/241; 398/16

(57) ABSTRACT

A testing system for testing a network apparatus has a plurality of network ports. The system includes a signal generating device for providing a test packet to the network apparatus; a network apparatus connecting device for connecting to the network apparatus; a switching device for switching between a plurality of router lines; and a controlling device for controlling a test procedure, by controlling selection and cycling of the router lines to perform a test on the network ports one by one and allowing the network ports to return the test packet by the test packet return instruction. Accordingly, the network connection status of the network ports of the network apparatus is determined according to the test packet. The test system allows a test to be conducted on the network ports of the network apparatus quickly and at low costs.

### CROSS-REFERENCE TO RELATED APPLICATION

This non-provisional application claims priority under 35 U.S.C.§119(a) on Patent Application No(s).100113515 filed in Taiwan, R.O.C. on Apr. 19, 2011, the entire contents of which are hereby incorporated by reference.

### FIELD OF TECHNOLOGY

The present invention relates to testing systems, and more particularly, to a system for testing a network apparatus having a plurality of network ports.

### BACKGROUND

At present, the point-to-point data packet transmission between a client end and a servo end on the Internet is governed by the Internet Protocol (IP). A local area network (LAN) or a wide area network (WAN) provides connection between a plurality of user ends or connection between a plurality of networks by means of devices, such as a hub, an access point (AP), a broadband router, and a router having at least one network interface function.

In order to enable the aforesaid network apparatuses to operate well at the client ends, manufacturers of the aforesaid network apparatuses usually conduct a test on the device before the delivery thereof to confirm that the network apparatuses can operate well. In this regard, the typical prior art is herein exemplified by an Internet router having a plurality of network ports. The Internet router receives a data packet generated by a flow generator (such as SmartBits gauge), tests a data packet delivered by each of the network ports and located on the Internet router by means of a testing network interface gradually, and determines whether the Internet router meets the Internet transmission specifications according to the status of the data packet (the status includes a packet transmission success rate, delivery delay time, etc.). Also, to enhance the speed and automation of the test, it is necessary to provide the testing network interfaces of the same quantity as the network ports. However, the number of the testing network interface can only be increased at the expense of testing costs.

To solve the above problem, another solution involves performing a “plugging and unplugging” network test on the aforesaid network ports manually by means of a single network interface. However, the “plugging and unplugging” operation is resources-intensive, laborious, and susceptible to inaccuracy.

Taiwan Published Patent Application 200705884, entitled Network Apparatuses Testing Method and System, discloses a network apparatus testing method and system for performing a transmission reliability test procedure on a network apparatus by means of a response detection function of a network system and universal test standard specification so as to ensure that any test results thus obtained will be recognized globally and universally, and the test thus conducted will reduce manpower and procurement costs to an extent greater than the prior art does, dispense with the special training otherwise given to engineers, and dispense with the procurement of expensive test apparatuses, such that the testing operation of the network apparatuses will be cost-efficient. However, although Taiwan Published Patent Application 200705884 discloses switching between network connection devices in order to test a network apparatus (such as an Ethernet card) having a single interface port, it fails to address the issue of testing a network apparatus having a plurality of interface ports.

As describe above, related conventional testing methods, whether automated or manually operated, are always flawed with drawbacks, such as the requirement for a plurality of testing network interface. Accordingly, it is imperative to provide a testing system which is efficient in overcoming the drawbacks of the prior art.

### SUMMARY

It is a primary objective of the present invention to provide a testing system for performing a network connection test at a low cost and a high speed, by using one or more network apparatuses each having a plurality of network ports.

In order to achieve the above and other objectives, the present invention provides a testing system for use in testing a network apparatus having a plurality of network ports. The testing system comprises: a signal generating device for providing a test packet; a network apparatus connecting device comprising a plurality of testing ports and a test packet port connected to the signal generating device, the testing ports enabling the network ports to be separately connected and operated, and the test packet port enabling the network ports to be connected and operated, wherein the test packet is sent to the network apparatus through the test packet port;

a switching device having a plurality of switchable router lines each being connected to a corresponding one of the testing ports; and a controlling device connected to the switching device for generating a control signal adapted to control sequential switching of the router lines of the switching device such that the controlling device sequentially selects one of the router lines, the controlling device being capable of generating a test packet return instruction to be sent to the network apparatus via the selected router line, wherein the test packet return instruction enables the network apparatus to send the test packet to the controlling device via the selected router line and a corresponding one of network ports, and the controlling device being capable of determining a network connection status of the network port corresponding to the selected router line according to the test packet received.

In an embodiment, the network apparatus connecting device further comprises a sensing device connected to the controlling device for sensing a status of connection between the network apparatus and the network apparatus connecting device and then the sensing device sending a ready signal to the controlling device for responding to a connected status based on the network apparatus already connected to the network apparatus connecting device, the ready signal enabling the controlling device to generate the control signal.

In an embodiment, the signal generating device comprises: a server for generating an electrical test signal; an optical line terminal connected to the server for converting the electrical test signal into an optical test signal; and an optical splitter connected to the optical line terminal for providing a plurality of said optical test signals concurrently. The network apparatus connecting device further comprises a phototransducer connected to the test packet port and the optical splitter for converting the optical test signal generated by the signal generating device into the electrical test signal for functioning as the test packet.

Compared with the prior art, the present invention provides a testing system for testing a network apparatus having a plurality of network ports, such that the network apparatus receives a test packet and a test packet return instruction (such as a ping instruction) for testing a network layer. The test packet and the test packet return instruction are transmitted via router lines which are switchable by a switching device in a controllable manner, such that each of the network ports can be tested for compliance with the network transmission requirements when the network ports are switched sequentially by the switching device.

The present invention discloses a monitoring server for monitoring a network connection status attributed to the network apparatus and detected by the controlling devices. The monitoring server can be connected to a plurality of testing systems for integrating the testing systems.

Accordingly, the present invention overcomes the drawbacks of the prior art, including the need to provide a high-level network testing apparatus (such as SmartBits gauge) with multiple-port interfaces under test in order to conduct a network test on a plurality of network ports, and the need to perform multiple instances of “plugging and unplugging” operation in order to conduct a network test on a plurality of network ports, thereby resulting in inaccuracy and a waste of time.

### BRIEF DESCRIPTION OF THE DRAWINGS

Objectives, features, and advantages of the present invention are hereunder illustrated with specific embodiments in conjunction with the accompanying drawings, in which:

FIG. 1 is a flowchart of a testing method according to an embodiment of the present invention;

FIG. 2 is a schematic view of a testing system according to the first embodiment of the present invention;

FIGS. 3a-3b are schematic views of sequential testing according to the first embodiment of the present invention; and

FIG. 4 is a schematic view of the testing system according to the second embodiment of the present invention.

### DETAILED DESCRIPTION

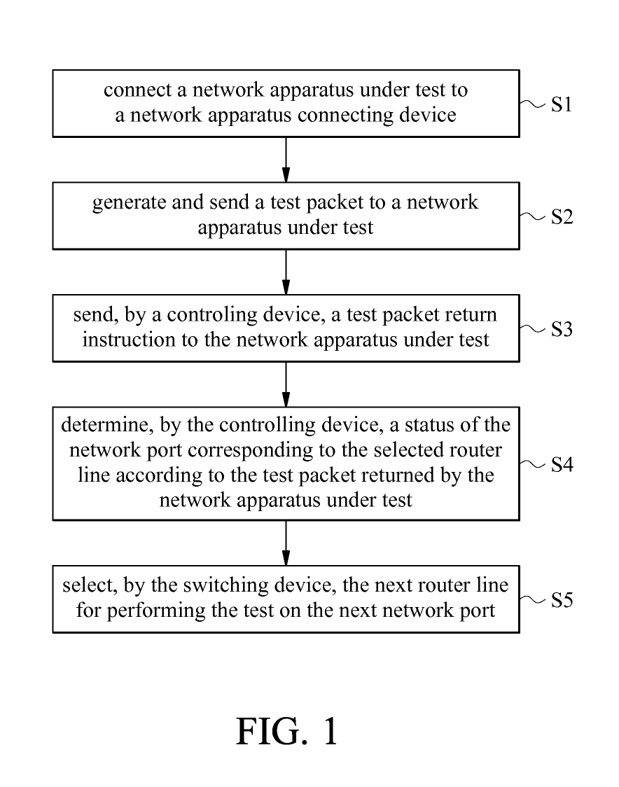

Referring to FIG. 1, there is shown a flowchart of a testing method according to an embodiment of the present invention. As shown in FIG. 1, the testing method is for testing a network apparatus having a plurality of network ports. For example, the network apparatus is an Internet protocol switch), a router, a hub, or a bridge. The network apparatus meets the requirements of the third layer, that is, the network layer, of the Open System Interconnection Reference Model (OSI) architecture. Hence, the network layer regulates the packet transmission protocol required for the network apparatus on the Internet. The packet transmission protocol determines the recipient address to which a data packet is delivered and selects the optimal path of delivery of the data packet.

In this regard, the testing method starts with step S1 which involves connecting a network apparatus under test to a network apparatus connecting device so as to enable connection of the ports of the network apparatus.

Step S2 involves providing a test packet for a network apparatus connecting device comprising a plurality of testing ports and a test packet port, wherein the testing ports are connected to the network ports (such as a LAN port) of the network apparatus, and the test packet port is connected to the network ports (such as a WAN port) of the network apparatus. The test packet is sent via the test packet port to the network apparatus under test. The test packet comprises a series of data packets generated virtually in accordance with the network requirements.

In step S3, a controlling device controllably drives, by means of the output of a control signal, a switching device to select a predetermined router line, such that a test packet return instruction is sent to the network apparatus under test via the selected router line, thereby allowing a packet transmission test to be performed on the network ports of the network apparatus. The purpose of the test packet return instruction is to start the delivery of a data packet for use with the network apparatus under test within the Internet Protocol (IP) architecture. The operation of the test packet return instruction comprises sending an instruction of the Internet Control Message Protocol (ICMP) (or known as a request instruction) to the network ports of the network apparatus via the router lines. After receiving the test packet return instruction, the network apparatus returns the test packet.

In step S4, the controlling device estimates a packet loss tolerance and a packet round-trip time (or known as a network round-trip delay time) according to the time taken to receive the test packet and the test packet receipt success rate, and determines a status of network connection of the network port corresponding to the selected router line according to the time taken to receive the test packet and the test packet receipt success rate. Hence, if the time taken to receive the test packet and the test packet receipt success rate meet the requirement of Internet-based data transmission, then it will be determined that the network connection status of the network port under test is normal, otherwise it will be determined that the network connection status of the network port under test is abnormal.

Step S5 involves selecting, by the switching device, the next router line for performing the test on the next network port. With the test packet return instruction, the network ports corresponding to the router lines are selectively selected according to the control signal of the controlling device by means of router line control. In an embodiment, the routing process is effectuated by switching the router lines sequentially according to the control signal operable only within a specific time period, such that within the specific time period the test packet return instruction is sent to the network ports in sequence. Moreover, the test packet corresponding to each of the network ports can be obtained by the aforesaid routing manner.

The testing method further comprises the step of setting the IP address and the subnet mask of the monitoring server so as to monitor a network connection status of the network ports under test. Hence, given the IP address and the subnet mask of the monitoring server, it is feasible for the monitoring server to monitor the network connection status of the network ports connected to the testing ports. Also, the aforesaid steps are applicable to a test performed on a single network apparatus. In another embodiment, the monitoring server can concurrently monitor the network connection statuses of the network ports of a plurality of network apparatuses to thereby test and monitor the network apparatuses concurrently, intensively, and quickly. Hence, in case of irregularity of any one of the network ports of the network apparatuses, for example, an error related to a network connection status, the monitoring server can identify the malfunctioning network apparatus quickly and accurately.

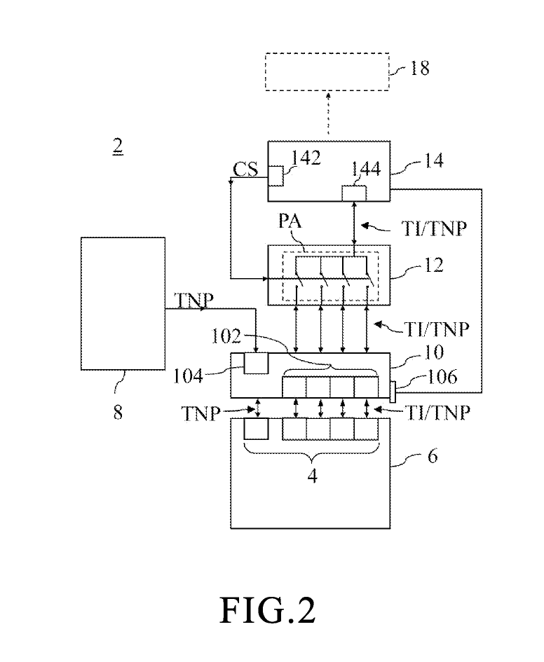

Referring to FIG. 2, there is shown a schematic view of a testing system according to the first embodiment of the present invention. As shown in FIG. 2, a network apparatus testing system 2 is for use in testing a network apparatus 6 having a plurality of network ports 4, and the network apparatus 6 meets the requirements of the third layer, that is, the network layer, of the Open System Interconnection Reference Model (OSI) architecture.

The testing system 2 comprises a signal generating device 8, a network apparatus connecting device 10, a switching device 12, and the controlling device 14.

The signal generating device 8 generates a test packet TNP. The test packet TNP is the basic unit of information being transmitted within a packet exchange network. The network apparatus connecting device 10 is connected to the signal generating device 8. The network apparatus connecting device 10 comprises a plurality of testing ports 102 and a test packet port 104 connected to the signal generating device 8. The testing ports 102 are connected to the test packet ports 104 in a manner comparable to the relationship between a LAN and a WAN in a typical network apparatus. The testing ports 102 enable the network ports 4 of the network apparatus 6 to be separately connected and operated. Both the testing ports 102 and the test packet port 104 are for use in transmitting the test packet TNP.

The switching device 12 comprises a plurality of router lines PA. The switching device 12 is connected to the network apparatus connecting device 10. The testing ports 102 are connected to the router lines PA, respectively, in a one-to-one manner. For example, the router lines PA comprise a plurality of control switches arranged in matrix.

The controlling device 14 is connected to the switching device 12. The controlling device 14 is capable of generating a control signal CS for controlling the switching of the router lines PA. The controlling device 14 is also capable of generating a test packet return instruction TI for testing a network layer of the network apparatus 6. The test packet return instruction TI is sent to a corresponding one of the testing ports 102 via the router lines PA. The testing port 102 that receives the test packet return instruction TI returns the test packet TNP to the controlling device 14 via the router lines PA. The controlling device 14 determines a network connection status of the network apparatus 6 according to the test packet TNP returned.

The network apparatus connecting device 10 further comprises a sensing device 106 connected to the controlling device 14. The sensing device 106 senses the status of connection between the network apparatus 6 and the network apparatus connecting device 10, and then the sensing device 106 sends a ready signal to the controlling device 14 for responding to a connected status based on the network apparatus already connected to the network apparatus connecting device, the ready signal enabling the controlling device to generate the control signal. The ready signal enables the controlling device 14 to determine whether to perform a testing step. In the event that the network apparatus 6 and the network apparatus connecting device 10 are not properly connected, the sensing device 106 does not send the ready signal and thereby does not trigger the testing step of the controlling device 14.

Also, the testing system 2 further comprises a monitoring server 18 connected to the controlling device 14 for monitoring a network connection status attributed to the network apparatus 6 under test and detected by the controlling device 14.

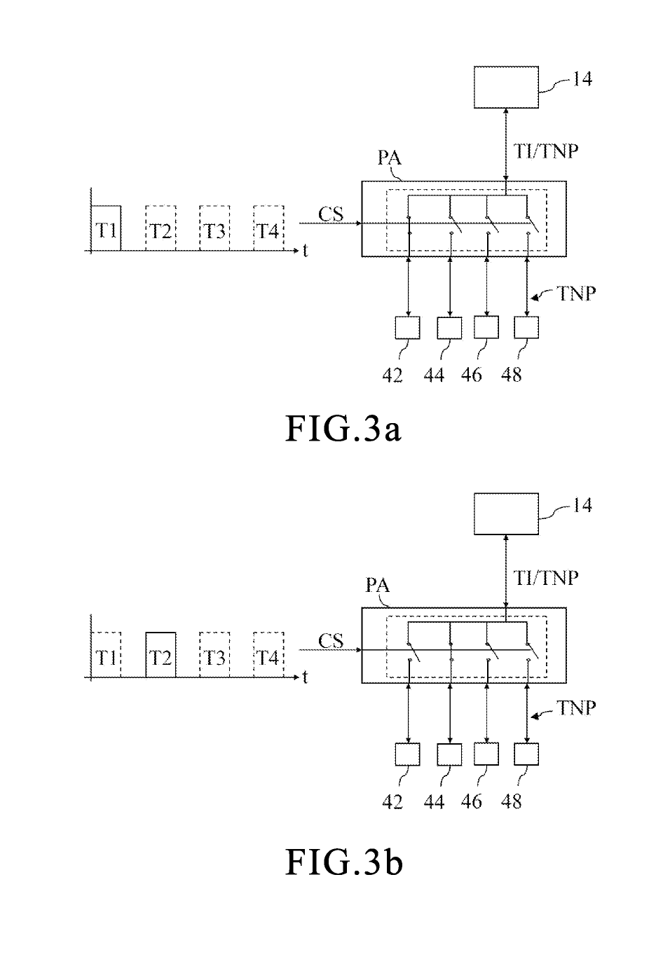

The sequential transmission of the test packet return instruction TI is illustrated in FIGS. 3a-3b. Referring to FIG. 3a, during the first time period T1, the router lines PA enable the controlling device 14 to be connected to first network ports 42 of the network ports 4 (shown in FIG. 2), such that the controlling device 14 sends the test packet return instruction TI to the network apparatus 6 through the router lines PA and the first network ports 42, so as to request the network apparatus 6 to return the test packet TNP generated by the signal generating device 8 to the controlling device 14 through the first network interface 42. Afterward, the controlling device 14 determines a network connection status of the first network ports 42 according to the returned test packet TNP. The determination of the network connection status of the first network ports 42 is made according to the time taken by the controlling device 14 to receive the returned test packet TNP and the receipt success rate thereof. Finally, the controlling device 14 estimates a packet loss tolerance and a packet round-trip time (or known as a network round-trip delay time) so as to determine whether the first network ports 42 meet the requirement of Internet-based data transmission.

Referring to FIG. 3b, once the first time period T1 ends to thereby usher in the second time period T2, the router lines PA will switch from the first network ports 42 of the network ports 4 to second network ports 44 of the network ports 4, such that the controlling device 14 can send the test packet return instruction TI to the network apparatus 6 through the router lines PA and the second network ports 44, so as to request the network apparatus 6 to return the test packet TNP generated by the signal generating device 8 to the controlling device 14 via the second network interface 44. Then, the controlling device 14 determines a network connection status of the second network ports 44 according to the returned test packet TNP and thereby determines whether the second network ports 44 meet the requirement of Internet-based data transmission. In the same analogy, during the time periods T1-T4, the controlling device 14 sequentially determines the network connection status of the network ports 42-48 and thereby determines whether the network ports 42-48 meet the requirement of the network layer of the Open System Interconnection Reference Model (OSI). Prior to the commencement of the second time period T2, it is necessary for the test packet return procedure to be completely performed on the first network ports 42.

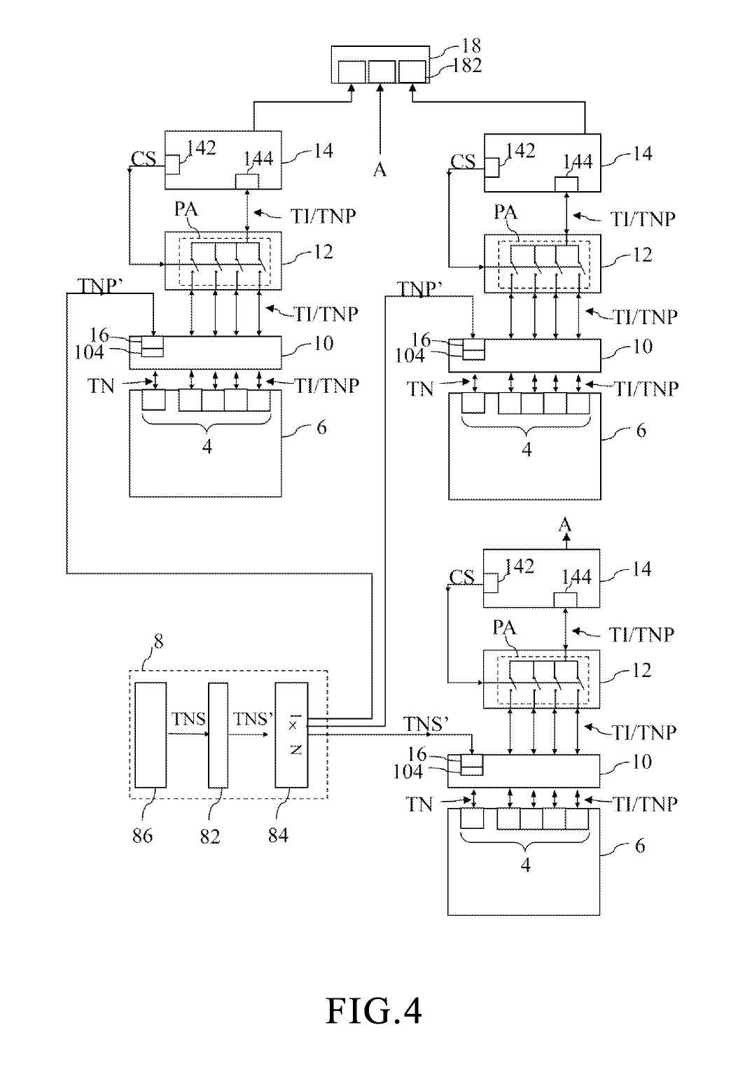

Referring to FIG. 4, there is shown a schematic view of a network apparatus testing system according to the second embodiment of the present invention. As shown in FIG. 4, the signal generating device 8 further comprises an optical line terminal 82, an optical splitter 84, and a server 86. The server 86 is for use in generating an electrical test signal TNS. The optical line terminal 82 converts the electrical test signal TNS generated by the server 86 into an optical test signal TNS' which is then turned concurrently, with the optical splitter 84, into a plurality of said optical test signals TNS' for being sent to the network apparatus connecting device 10 having a phototransducer 16. The optical splitter 84 a one-to-many (that is, “one input, many outputs”) optical splitter. The optical splitter 84 divides a single said optical test signal TNS' into a plurality of said optical test signals TNS'.

The phototransducer 16 is connected to the test packet port 104 and the optical splitter 84. The phototransducer 16 converts the optical test signal TNS' which is generated by the signal generating device 8 into the electrical test signal TNS for functioning as the test packet, such that the network apparatus test procedure in the first embodiment can take place.

Likewise, the testing system 2 further comprises the monitoring server 18. The monitoring server 18 comprises a plurality of ports 182 connected to a plurality of said controlling devices 14, respectively. The monitoring server 18 monitors a network connection status attributed to the network apparatus 6 and detected by the controlling devices 14.

In conclusion, the present invention overcomes the drawbacks of the prior art, including the need to provide a high-level network testing apparatus (such as SmartBits gauge) with multiple-port interfaces under test in order to conduct a network test on a plurality of network ports, and the need to perform multiple instances of “plugging and unplugging” operation in order to conduct a network test on a plurality of network ports, thereby resulting in inaccuracy and a waste of time.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A testing system for testing a network apparatus having a plurality of network ports, comprising:
a signal generating device for providing a test packet;
a network apparatus connecting device comprising a plurality of testing ports and a test packet port connected to the signal generating device, the testing ports enabling the network ports to be separately connected and operated, and the test packet port enabling the network ports to be connected and operated, wherein the test packet is sent to the network apparatus through the test packet port;
a switching device having a plurality of switchable router lines each being connected to a corresponding one of the testing ports; and
a controlling device connected to the switching device for generating a control signal adapted to control sequential switching of the router lines of the switching device such that the controlling device sequentially selects one of the router lines, the controlling device being capable of generating a test packet return instruction to be sent to the network apparatus via the selected router line, wherein the test packet return instruction enables the network apparatus to send the test packet to the controlling device via the selected router line and the corresponding one of network ports, and the controlling device being capable of determining a network connection status of the network port corresponding to the selected router line based on the test packet received.

2. The testing system of claim 1, wherein the router lines comprise a plurality of control switches arranged in matrix.

3. The testing system of claim 1, wherein the network apparatus connecting device further comprises a sensing device connected to the controlling device for sensing a status of connection between the network apparatus and the network apparatus connecting device, and the sensing device sending a ready signal to the controlling device for responding to a connected status based on the network apparatus already connected to the network apparatus connecting device, the ready signal enabling the controlling device to generate the control signal.

4. The testing system of claim 3, further comprising a monitoring server connected to the controlling device for monitoring a network connection status of the network apparatus.

5. The testing system of claim 3, wherein the signal generating device comprises:
a server for generating an electrical test signal;
an optical line terminal connected to the server for converting the electrical test signal into an optical test signal; and
an optical splitter connected to the optical line terminal for providing a plurality of said optical test signals concurrently.
wherein the network apparatus connecting device further comprises a phototransducer connected to the test packet port and the optical splitter for converting the optical test signal generated by the signal generating device into the electrical test signal for functioning as the test packet.
